(19) United States
(12) Patent Application Publication
(10) Pub. No.: US 2026/0226265 A1
(43) Pub. Date: Aug. 6, 2026

(54) RECYCLATE-CONTAINING POLYPROPYLENE COMPOSITIONS WITH EXCELLENT MECHANICAL PROPERTIES AND LOW EMISSIONS

(71) Applicant: BOREALIS AG, Vienna (AT)

(72) Inventors: Daniela Mileva, Linz (AT); Markus Gall, Linz (AT); Hermann Braun, Linz (AT); Robert Gubo, Linz (AT)

(21) Appl. No.: 19/157,420

(22) PCT Filed: Feb. 23, 2024
(86) PCT No.: PCT/EP2024/054650

§ 371 Date: Aug. 18, 2025

(30) Foreign Application Priority Data
Feb. 23, 2023 (EP) 23158239.6

(51) Int. Cl. C08L 23/14; C08K 3/34; C08K 5/01; C08K 5/09

(52) U.S. Cl. CPC C08L 23/142; C08K 3/34; C08K 5/01; C08K 5/09; C08K 2003/343; C08K 2201/005; C08L 2205/025; C08L 2205/035; C08L 2207/20

(57) ABSTRACT

A polypropylene composition (PC) being a mixed-plastic polypropylene blend, being obtainable by blending at least components a) to e): a) from 15.0 to 40.0 wt.-%, of a HECO having an MFR₂ of 12 to 70 g/10 min; b) from 30.0 to 60.0 wt.-% of a mixed-plastic polypropylene blend (B) having an MFR₂ of 16 to 50 g/10 min and an amount of defects with a particle size in the range from 0.05 to 0.10 mm² in the range from 0.1 to 1.0 particles/cm²; c) from 18.0 to 25.0 wt.-% of an inorganic filler (F); d) optionally, from 0.0 to 15.0 wt.-% of a propylene homopolymer (h-PP) having an MFR₂ of 50 to 200 g/10 min; and e) from 0.2 to 5.0 wt.-%, of further additive(s) (A).

### FIELD OF THE INVENTION

The present invention relates to a polypropylene composition (PC) being a mixed-plastic polypropylene blend containing recycled material and to articles comprising said polypropylene composition (PC).

### BACKGROUND TO THE INVENTION

Polyolefins, in particular polyethylene and polypropylene, are increasingly consumed in large amounts in a wide range of applications, including packaging for food and other goods, fibres, automotive components, and a great variety of manufactured articles.

Polypropylene based materials offer significant potential for mechanical recycling, as these materials are extensively used in packaging. Taking into account the huge amount of waste collected compared to the amount of waste recycled back into the stream, there is still a great potential for intelligent reuse of plastic waste streams and for mechanical recycling of plastic wastes.

Development of polyolefins and polyolefin blends is often focused on the continuous goal of improving the balance of mechanical properties, and also the more effective handling of waste streams, for both economical and also environmental reasons. It is usually understood that the use of recycled materials in polymer blends tends to lead to a degradation of mechanical properties, since the mechanical properties of virgin polymers can be easily modified by the polymerization conditions, whereas controlling the properties of a recycled material is intrinsically more difficult, resulting in poorer performance of these compositions.

Under-the-bonnet automotive articles are positioned close to the engine of the automotive, which is a high-stress environment, requiring an excellent balance of (thermo-) mechanical properties, including a stiffness/toughness balance and low emissions. This applies in particular to applications such as housings for heating, ventilation and air-conditioning.

Recently, the demand of the market has expanded in direction of using recycled polyolefins in blends with virgin polymers in order to fulfil specific requirements.

However, there is a deeply felt need for allowing the reuse of post-consumer polyolefin recyclates in final products without health and safety hazards.

Due to the poor homogeneity of recyclate blends, it is generally observed that properties that would be desirable for automotive under-the-bonnet articles are notably lower for such recyclate blends than for similar virgin polymers. Furthermore, it is known that post-industrial recyclates typically have improved properties, relative to post-consumer recyclates, since post-industrial recyclates are generally gathered in a much more controlled manner and result from the mixing of fewer individual polymer grades and polymer types than would be the case for post-consumer recyclates. Likewise, since post-industrial recyclates have generally not had a first use cycle, for example as a container for cosmetics or food, they are far less contaminated with volatile and semi-volatile organic compounds, which are responsible for the often poor odor of post-consumer recyclates.

As such, there remains a need for recyclate-containing blends that contain high amounts of post-consume recyclate and maintain the balance of mechanical and odor properties required for automotive under-the-bonnet articles.

As such, there remains a need for recyclate-containing blends with an excellent balance of (thermos-) mechanical properties, including a stiffness/toughness balance and low emissions, enabling the use of recyclates in under-the-bonnet automotive articles.

### SUMMARY OF THE INVENTION

The present invention is based on the finding that the blending of a particular post-consumer recyclate blend with a heterophasic propylene-ethylene copolymer, a propylene homopolymer, a filler, and various additives results in the formation of polypropylene compositions with well balanced properties despite the presence of post-consumer recyclate.

Therefore, in a first aspect, the present invention is directed to a polypropylene composition (PC) being a mixed-plastic polypropylene blend, being obtainable by blending at least components a) to e):
a) from 15.0 to 40.0 wt.-%, relative to the total weight of the polypropylene composition (PC), of a heterophasic propylene-ethylene copolymer (HECO) having a melt flow rate (MFR₂), determined according to ISO 1133 at 230° C. and 2.16 kg, in the range from 12 to 70 g/10 min;
b) from 30.0 to 60.0 wt.-%, relative to the total weight of the polypropylene composition (PC), of a mixed-plastic polypropylene blend (B) having a melt flow rate (MFR₂), determined according to ISO 1133 at 230° C. and 2.16 kg, in the range from 16 to 50 g/10 min and an amount of defects with a particle size in the range from 0.05 to 0.10 mm² in the range from 0.1 to 1.0 particles/cm²;
c) from 18.0 to 25.0 wt.-%, relative to the total weight of the polypropylene composition (PC), of an inorganic filler (F);
d) optionally, from 0.0 to 15.0 wt.-%, relative to the total weight of the polypropylene composition (PC), of a propylene homopolymer (h-PP) having a melt flow rate (MFR₂), determined according to ISO 1133 at 230° C. and 2.16 kg, in the range from 50 to 200 g/10 min; and
e) from 0.2 to 5.0 wt.-%, relative to the total weight of the polypropylene composition (PC), of further additive(s) (A),
   wherein the total contents of components a) to e) add up to at least 98 wt.-%, more preferably at least 99 wt.-%, most preferably 100 wt.-%, relative to the total weight of the polypropylene composition (PC).

In a further aspect, the present invention is directed to an article, preferably an injection-moulded article, comprising the polypropylene composition (PC) of the first or second aspects in an amount of at least 95 wt.-%, more preferably at least 98 wt.-%, most preferably at least 99 wt.-%.

### Definitions

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below.

Unless clearly indicated otherwise, use of the terms “a,” “an,” and the like refers to one or more.

In the following, amounts are given in % by weight (wt.-%) unless it is stated otherwise.

A propylene homopolymer is a polymer that essentially consists of propylene monomer units. Due to impurities especially during commercial polymerization processes, a propylene homopolymer can comprise up to 0.1 mol % comonomer units, preferably up to 0.05 mol % comonomer units and most preferably up to 0.01 mol % comonomer units.

A propylene copolymer is a copolymer of propylene monomer units and comonomer units, preferably selected from ethylene and C₄-C₈ alpha-olefins. A propylene random copolymer is a propylene copolymer wherein the comonomer units are randomly distributed along the polymer chain, whilst a propylene block copolymer comprises blocks of propylene monomer units and blocks of comonomer units. Propylene random copolymers can comprise comonomer units from one or more comonomers different in their amounts of carbon atoms.

Heterophasic propylene copolymers typically comprise:
a) a crystalline propylene homopolymer or copolymer matrix (M); and
b) an elastomeric rubber, preferably a propylene-ethylene copolymer (E);

In case of a random heterophasic propylene copolymer, said crystalline matrix phase is a random copolymer of propylene and at least one alpha-olefin comonomer.

The elastomeric phase can be a propylene copolymer with a high amount of comonomer that is not randomly distributed in the polymer chain but is distributed in a comonomer-rich block structure and a propylene-rich block structure. A heterophasic polypropylene usually differentiates from a one-phasic propylene copolymer in that it shows two distinct glass transition temperatures Tg which are attributed to the matrix phase and the elastomeric phase.

For the purposes of the present description and of the subsequent claims, the term “recycled waste” is used to indicate a material recovered from both post-consumer waste and industrial waste, as opposed to virgin polymers. Post-consumer waste refers to objects having completed at least a first use cycle (or life cycle), i.e. having already served their first purpose; while industrial waste refers to manufacturing scrap, which does not normally reach a consumer.

The term “virgin” denotes the newly produced materials and/or objects prior to their first use, which have not already been recycled.

The term “recycled material” such as used herein denotes materials reprocessed from “recycled waste”.

A polymer blend denotes a mixture of two or more polymeric components. In general, the blend can be prepared by mixing the two or more polymeric components. Suitable mixing procedures known in the art are post-polymerization blending procedures.

Post-polymerization blending can be dry blending of polymeric components such as polymer powders and/or compounded polymer pellets or melt blending by melt mixing the polymeric components.

A mixed-plastic polypropylene blend indicates that the blend predominantly comprises polypropylene; however, small amounts of other plastic are present. Recyclate blends, in particular post-consumer recyclate blends, are almost always mixed-plastic blends, which reflects the efficiency of the sorting in state of the art recycling processes.

The present invention will now be described in more detail.

### DETAILED DESCRIPTION

The present invention is directed to a polypropylene composition (PC) being a mixed-plastic polypropylene blend, being obtainable by blending at least components a) to e):
a) from 15.0 to 40.0 wt.-%, relative to the total weight of the polypropylene composition (PC), of a heterophasic propylene-ethylene copolymer (HECO);
b) from 30.0 to 60.0 wt.-%, relative to the total weight of the polypropylene composition (PC), of a mixed-plastic polypropylene blond (B);
c) from 18.0 to 25.0 wt.-%, relative to the total weight of the polypropylene composition (PC), of an inorganic filler (F);
d) optionally, from 0.0 to 15.0 wt.-%, relative to the total weight of the polypropylene composition (PC), of a propylene homopolymer (h-PP); and
e) from 0.2 to 5.0 wt.-%, relative to the total weight of the polypropylene composition (PC), of further additive(s) (A).

The total contents of components a) to e) add up to at least 98 wt.-%, more preferably at least 99 wt.-%, most preferably 100 wt.-%, relative to the total weight of the polypropylene composition (PC).

Preferably, the polypropylene composition (PC) is obtainable by blending at least components a) to c):
a) from 15.0 to 36.0 wt.-%, relative to the total weight of the polypropylene composition (PC), of a heterophasic propylene-ethylene copolymer (HECO);
b) from 35.0 to 57.0 wt.-%, relative to the total weight of the polypropylene composition (PC), of a mixed-plastic polypropylene blend (B);
c) from 18.0 to 23.0 wt.-%, relative to the total weight of the polypropylene composition (PC), of an inorganic filler (F);
d) optionally, from 1.0 to 12.0 wt.-%, relative to the total weight of the polypropylene composition (PC), of a propylene homopolymer (h-PP); and
e) from 0.2 to 5.0 wt.-%, relative to the total weight of the polypropylene composition (PC), of further additive(s) (A).

More preferably, the polypropylene composition (PC) is obtainable by blending at least components a) to e):
a) from 15.0 to 30.0 wt.-%, relative to the total weight of the polypropylene composition (PC), of a heterophasic propylene-ethylene copolymer (HECO);
b) from 40.0 to 55.0 wt.-%, relative to the total weight of the polypropylene composition (PC), of a mixed-plastic polypropylene blend (B);
c) from 19.0 to 21.0 wt.-%, relative to the total weight of the polypropylene composition (PC), of an inorganic filler (F);
d) optionally, from 5.0 to 10.0 wt.-%, relative to the total weight of the polypropylene composition (PC), of a propylene homopolymer (h-PP); and
e) from 0.2 to 5.0 wt.-%, relative to the total weight of the polypropylene composition (PC), of further additive(s) (A).

The blending of the polypropylene composition (PC) may be carried out according to a process comprising the steps of:
a) providing the heterophasic propylene-ethylene copolymer (HECO), the mixed-plastic polypropylene blend (B), the inorganic filler (F), the optional propylene homopolymer (h-PP) and the further additives (A);
b) blending and extruding the heterophasic propylene-ethylene copolymer (HECO), the mixed-plastic polypropylene blend (B), the inorganic filler (F), the optional propylene homopolymer (h-PP) and the further additives (A) at a temperature in the range from 120 to 250° C. in an extruder, preferably a twin-screw extruder, thereby generating the polypropylene composition (PC), preferably in pellet form.

In particular, it is preferred to use a conventional compounding or blending apparatus, e.g. a Banbury mixer, a 2-roll rubber mill, Buss-co-kneader or a twin-screw extruder. More preferably, mixing is accomplished in a co-rotating twin-screw extruder. The polymer materials recovered from the extruder are usually in the form of pellets.

The heterophasic propylene-ethylene copolymer (HECO)

The heterophasic propylene ethylene copolymer (HECO) is provided in an amount in the range from 15.0 to 40.0 wt.-%, more preferably in the range from 15.0 to 36.0 wt.-%, most preferably in the range from 15.0 to 30.0 wt.-%, relative to the total weight of the polypropylene composition (PC).

The heterophasic propylene ethylene copolymer (HECO) has a melt flow rate (MFR₂), determined according to ISO 1133 at 230° C. and 2.16 kg, in the range from 12 to 70 g/10 min, more preferably in the range from 15 to 50 g/10 min, most preferably in the range from 20 to 30 g/10 min.

The heterophasic propylene ethylene copolymer (HECO) preferably has an ethylene content (C2(total)), determined by CRYSTEX QC analysis, in the range from 1.0 to 6.0 wt.-%, more preferably in the range from 1.5 to 5.0 wt.-%, most preferably in the range from 2.0 to 4.0 wt.-%.

The heterophasic propylene ethylene copolymer (HECO) preferably has a soluble fraction (SF) content, determined by CRYSTEX QC analysis, in the range from 4.0 to 12.0 wt.-%, more preferably in the range from 5.0 to 10.0 wt.-%, most preferably in the range from 6.0 to 8.0 wt.-%.

The heterophasic propylene ethylene copolymer (HECO) preferably has an ethylene content of the soluble fraction (C2(SF)), determined by CRYSTEX QC analysis, in the range from 10 to 30 wt.-%, more preferably in the range from 15 to 26 wt.-%, most preferably in the range from 18 to 23 wt.-%.

The heterophasic propylene ethylene copolymer (HECO) preferably has an intrinsic viscosity of the soluble fraction (iV(SF)), determined by CRYSTEX QC analysis, in the range from 1.00 to 2.00 dL/g, more preferably in the range from 1.10 to 1.70 dL/g, most preferably in the range from 1.20 to 1.50 dL/g.

The heterophasic propylene ethylene copolymer (HECO) preferably has a crystalline fraction (CF) content, determined by CRYSTEX QC analysis, in the range from 88.0 to 96.0 wt.-%, more preferably in the range from 90.0 to 95.0 wt.-%, most preferably in the range from 92.0 to 94.0 wt.-%.

The first heterophasic propylene ethylene copolymer (HECO) preferably has an ethylene content of the crystalline fraction (C2(CF)), determined by CRYSTEX QC analysis, in the range from 0.0 to 3.0 wt.-%, more preferably in the range from 0.5 to 2.0 wt.-%, most preferably in the range from 0.5 to 1.5 wt.-%.

The heterophasic propylene ethylene copolymer (HECO) preferably has an intrinsic viscosity of the crystalline fraction (iV(CF)), determined by CRYSTEX QC analysis, in the range from 1.00 to 2.00 dL/g, more preferably in the range from 1.30 to 1.80 dL/g, most preferably in the range from 1.50 to 1.70 dL/g.

It is also preferred that the ratio of the intrinsic viscosity of the soluble and crystalline fractions, (iV(SF)/iV(CF)), determined by CRYSTEX QC analysis, is in the range from 0.50 to 1.00, more preferably in the range from 0.67 to 0.95, most preferably in the range from 0.75 to 0.90.

### The Mixed-Plastic Polypropylene Blend (B)

The mixed-plastic polypropylene blend (B) is provided in an amount in the range from 30.0 to 60.0 wt.-%, more preferably in the range from 35.0 to 57.0 wt.-%, most preferably in the range from 40.0 to 55.0 wt.-%, relative to the total weight of the polypropylene composition (PC).

The mixed-plastic polypropylene blend (B) is a polypropylene rich recycled material, meaning that it comprises significantly more polypropylene than polyethylene. Recycled waste streams, which are high in polypropylene can be obtained for example from the automobile industry, particularly as some automobile parts such as bumpers are sources of fairly pure polypropylene material in a recycling stream.

Preferably, the polypropylene rich recycled material is obtained from recycled waste by means of plastic recycling processes known in the art. Such recyclates are commercially available, e.g. from Corepla (Italian Consortium for the collection, recovery, recycling of packaging plastic wastes), Resource Plastics Corp. (Brampton, ON), Kruschitz GmbH, Plastics and Recycling (AT), Vogt Plastik GmbH (DE), Mtm Plastics GmbH (DE) etc. Non-exhaustive examples of polypropylene rich recycled materials include: Purpolen® PP (Mtm Plastics GmbH), Axpoly® recycled polypropylene pellets (Axion Ltd) and PolyPropylene Copolymer (BSP Compounds).

During recycling, any reasonable measure will usually be taken for any components other than polyethylene and polypropylene to be reduced/removed as far as the final application or use suggests such measures; however, other components are often present in small amounts.

Other such components include polystyrene (PS), polyamides (PA), polyethylene terephthalate (PET), which are all present in as low an amount as possible, preferably below the detection limit.

The mixed-plastic polypropylene blend (B) has a melt flow (MFR₂), determined according to ISO 1133 at 230° C. and 2.16 kg, in the range from 16.0 to 50 g/10 min, more preferably in the range from 18 to 40 g/10 min, most preferably in the range from 20 to 30 g/10 min.

The mixed-plastic polypropylene blend (B) preferably has an ethylene content (C2(total)), determined by CRYSTEX QC analysis, in the range from 2.0 to 10.0 wt.-%, more preferably in the range from 3.0 to 8.0 wt.-%, most preferably in the range from 4.0 to 6.0 wt.-%.

The mixed-plastic polypropylene blend (B) preferably has a has a soluble fraction (SF) content, determined by CRYSTEX QC analysis, in the range from 5.0 to 20.0 wt.-%, more preferably in the range from 7.0 to 15.0 wt.-%, most preferably in the range from 9.0 to 13.0 wt.-%.

The mixed-plastic polypropylene blend (B) preferably has a has a crystalline fraction (CF) content, determined by CRYSTEX QC analysis, in the range from 80.0 to 95.0 wt.-%, more preferably in the range from 85.0 to 93.0 wt.-%, most preferably in the range from 87.0 to 91.0 wt.-%.

The mixed-plastic polypropylene blend (B) preferably has an ethylene content of the soluble fraction (C2(SF)), determined by CRYSTEX QC analysis, in the range from 20.0 to 40.0 wt.-%, more preferably in the range from 23.0 to 35.0 wt.-%, most preferably in the range from 25.0 to 30.0 wt.-%.

The mixed-plastic polypropylene blond (B) preferably has an ethylene content of the crystalline fraction (C2(CF)), determined by CRYSTEX QC analysis, in the range from 0.5 to 6.0 wt.-%, more preferably in the range from 1.0 to 5.0 wt.-%, most preferably in the range from 2.0 to 4.0 wt.-%.

The mixed-plastic polypropylene blend (B) preferably has an intrinsic viscosity of the soluble fraction (iV(SF)), determined by CRYSTEX QC analysis, in the range from 1.20 to 2.20 dL/g, more preferably in the range from 1.40 to 2.00 dL/g, most preferably in the range from 1.60 to 1.80 dL/g.

The mixed-plastic polypropylene blend (B) preferably has an intrinsic viscosity of the crystalline fraction (iV(CF)), determined by CRYSTEX QC analysis, in the range from 1.10 to 2.10 dL/g, more preferably in the range from 1.25 to 1.90 dL/g, most preferably in the range from 1.40 to 1.70 dL/g.

The mixed-plastic polypropylene blend (B) preferably has an inorganic residue content, as determined by calcination analysis according to DIN ISO 1172:1996, of 0.05 to 5.0 wt.-%, more preferably in the range from 0.10 to 3.0 wt.-%, most preferably in the range from 0.50 to 2.0 wt.-%

The mixed-plastic polypropylene blend (B) has an amount of defects with a particle size in the range from 0.05 to 0.10 mm² in the range from 0.1 to 1.0 particles/cm².

Having an amount of defects in this range is indicative that the mixed-plastic polypropylene blend (B) originates from post-consumer waste.

The mixed-plastic polypropylene blend (B) preferably originates from post-consumer waste.

Further indications of the recycled-nature of the mixed-plastic polypropylene blend (B) include the presence of other polymers, such as polystyrene and polyamide-6, and the presence of limonene and/or fatty acids.

Accordingly, it is further preferred that the mixed-plastic polypropylene blend (B) comprises one or more of polystyrene, polyamide-6, limonene and fatty acids, preferably comprises each of polystyrene, polyamide-6, limonene and fatty acids.

The mixed-plastic polypropylene blend (B) preferably has a Charpy Notched impact strength at 23° C., determined according to ISO 179 using 80× 10×4 mm³ test bars injection-moulded in line with ISO 19069-2, in the range from 1.0 to 20.0 kJ/m², more preferably in the range from 2.0 to 15.0 kJ/m², most preferably in the range from 3.0 to 10.0 kJ/m².

The mixed-plastic polypropylene blend (B) preferably has a flexural modulus, determined according to ISO 178 using 80×10×4 mm³ test bars injection-moulded in line with ISO 19069-2, in the range from 1000 to 1600 MPa, more preferably in the range from 1100 to 1500 MPa, most preferably in the range from 1200 to 1400 MPa.

The mixed-plastic polypropylene blend (B) preferably has a density, determined according to ISO 1183-187, in the range from 890 to 950 kg/m³, more preferably in the range from 900 to 940 kg/m³, most preferably in the range from 910 to 930 kg/m³.

The mixed-plastic polypropylene blend (B) preferably has a CIELAB colour space (L*a*b) of
i) L* of from 30.0 to 90.0, more preferably from 40.0 to 70.0;
ii) a* of from −5.0 to 0.0;
iii) b* of from −5.0 to 5.0

Finally, it is preferred that the mixed-plastic polypropylene blend (B) has undergone an aeration process to reduce the content of volatile and semi-volatile organic compounds before being blended with the other components to form the polypropylene composition (PC).

### The Inorganic Filler (F)

The inorganic filler (F) is provided in an amount in the range from 18.0 to 25.0 wt.-%, more preferably in the range from 18.0 to 23.0 wt.-%, most preferably in the range from 19.0 to 21.0 wt.-%, relative to the total weight of the polypropylene composition (PC).

The inorganic filler (F) preferably has a median diameter (d₅₀), determined according to ISO 13320-1, in the range from 0.1 to 3.0 μm, more preferably in the range from 0.2 to 2.0 μm, most preferably in the range from 0.3 to 1.0 μm.

The inorganic filler (F) preferably has a top cut diameter (d₉₈), determined according to ISO 13320-1, in the range from 5.0 to 30.0 μm, more preferably in the range from 8.0 to 25.0 μm, most preferably in the range from 10.0 to 20.0 μm.

It is preferred that the inorganic filler is selected from the group containing talc, calcium carbonate, barium sulfate, mica, and mixtures thereof.

Most preferably, the inorganic filler (F) is talc.

The Propylene Homopolymer (h-PP)

The propylene homopolymer (h-PP), if present, is provided in an amount in the range from 0.0 to 15.0 wt.-%, more preferably in the range from 1.0 to 12.0 wt.-%, most preferably in the range from 5.0 to 10.0 wt.-%, relative to the total weight of the polypropylene composition (PC).

The propylene homopolymer (h-PP), if present, has a melt flow rate (MFR₂), determined according to ISO 1133 at 230° C. and 2.16 kg, in the range from 50 to 200 g/10 min, more preferably in the range from 60 to 150 g/10 min, most preferably in the range from 70 to 100 g/10 min.

The propylene homopolymer (h-PP), if present, preferably has a xylene cold soluble (XCS) content, determined according to ISO 16152 analysis, in the range from 0.5 to 6.0 wt.-%, more preferably in the range from in the range from 1.0 to 5.0 wt.-%, most preferably in the range from in the range from 2.0 to 4.0 wt.-%.

The propylene homopolymer (h-PP), if present, preferably has a melting temperature (Tm), determined by differential scanning calorimetry (DSC), in the range from 159 to 169° C., more preferably in the range from 161 to 168° C., most preferably in the range from 163 to 167° C.

The propylene homopolymer (h-PP), if present, is free of 2,1-regiodefects, as determined by 13C-NMR spectroscopy.

Being free of 2,1-regiodefects is an indication that the propylene homopolymer (h-PP) has been polymerized in the presence of a Ziegler-Natta catalyst.

Therefore it is further preferred that the propylene homopolymer (h-PP), if present, has been polymerized in the presence of a Ziegler-Natta catalyst.

### The Further Additive(s) (A)

The further additives (A) are provided in an amount in the range from 0.2 to 5.0 wt.-%. The skilled practitioner would be able to select suitable additives that are well known in the art.

The additives (A) are preferably selected from pigments, antioxidants, UV-stabilisers, anti-scratch agents, mould release agents, acid scavengers, lubricants, anti-static agents, and mixtures thereof.

It is understood that the content of additives (A), given with respect to the total weight of the polypropylene composition (PC), includes any carrier polymers used to introduce the additives to said polypropylene composition (PC), i.e. masterbatch carrier polymers. An example of such a carrier polymer would be a polypropylene homopolymer in the form of powder.

### The Polypropylene Composition (PC)

The polypropylene composition (PC) preferably has a melt flow rate (MFR₂), determined according to ISO 1133 at 230° C. and 2.16 kg, in the range from 12 to 70 g/10 min, more preferably in the range from 15 to 50 g/10 min, most preferably in the range from 20 to 30 g/10 min.

The polymeric part of the polypropylene composition (PC) may be characterized according to the CRYSTEX QC method using trichlorobenzene (TCB) as a solvent. This method is described below in the determination methods section. The crystalline fraction (CF) contains for the most part the matrix phase and only a small part of the elastomeric phase and the soluble fraction (SF) contains for the most part the elastomeric phase and only a small part of the matrix phase. In some cases, this method results in more useful data, since the crystalline fraction (CF) and the soluble fraction (SF) more accurately correspond to the matrix and elastomeric phases respectively. Due to the differences in the separation methods of xylene extraction and CRYSTEX QC method the properties of XCS/XCI fractions on the one hand and crystalline/soluble (CF/SF) fractions on the other hand are not exactly the same, meaning that the amounts of matrix phase and elastomeric phase can differ as well as the properties.

The polymeric part of the polypropylene composition (PC) preferably has an ethylene content (C2(total)), determined by CRYSTEX QC analysis, in the range from 2.0 to 7.0 wt.-%, more preferably in the range from 2.5 to 6.0 wt.-%, most preferably in the range from 3.0 to 5.0 wt.-%.

The polymeric part of the polypropylene composition (PC) preferably has an intrinsic viscosity (iV(total)), determined by CRYSTEX QC analysis, in the range from 1.00 to 2.00 dL/g, more preferably in the range from 1.20 to 1.80 dL/g, most preferably in the range from 1.40 to 1.60 dL/g.

The polymeric part of the polypropylene composition (PC) preferably has a soluble fraction (SF) content, determined by CRYSTEX QC analysis, in the range from 5.0 to 15.0 wt.-%, more preferably in the range from 7.0 to 13.0 wt.-%, most preferably in the range from 8.0 to 12.0 wt.-%

Said soluble fraction (SF) preferably has an ethylene content (C2(SF)) determined by CRYSTEX QC analysis, in the range from 15.0 to 35.0 wt.-%, more preferably in the range from 18.0 to 30.0 wt.-%, most preferably in the range from 20.0 to 28.0 wt.-%.

Said soluble fraction (SF) preferably has an intrinsic viscosity (iV(SF)), determined by CRYSTEX QC analysis, in the range from 1.00 to 2.00 dL/g, more preferably in the range from 1.20 to 1.70 dL/g, most preferably in the range from 1.30 to 1.50 dL/g.

The polymeric part of the polypropylene composition (PC) preferably has a crystalline fraction (CF) content, determined by CRYSTEX QC analysis, in the range from 85.0 to 95.0 wt.-%, more preferably in the range from 87.0 to 93.0 wt.-%, most preferably in the range from 88.0 to 92.0 wt.-%

Said crystalline fraction (CF) preferably has an ethylene content (C2(CF)) determined by CRYSTEX QC analysis, in the range from 1.5 to 6.0 wt.-%, more preferably in the range from 2.0 to 5.0 wt.-%, most preferably in the range from 2.5 to 4.0 wt.-%.

Said crystalline fraction (CF) also preferably has an intrinsic viscosity (iV(CF)), determined by CRYSTEX QC analysis, in the range from 1.00 to 2.00 dL/g, more preferably in the range from 1.20 to 1.80 dL/g, most preferably in the range from 1.40 to 1.60 dL/g.

The polypropylene composition (PC) preferably has a density, determined according to ISO 1183-187, in the range from 1020 to 1100 kg/m³, more preferably in the range from 1035 to 1085 kg/m³, most preferably in the range from 1050 to 1070 kg/m³.

The polypropylene composition (PC) preferably has an inorganic residue content, as determined according to ISO 3451-1:2019, of 18.0 to 25.0 wt.-%, more preferably of 18.0 to 23.0 wt.-%, most preferably of 19.0 to 21.0 wt.-%.

The polypropylene composition (PC) preferably has a heat deflection temperature A (HDT-A), determined according to ISO 75B with a load of 1.82 MPa, in the range from 60 to 70° C., more preferably in the range from 61 to 68° C., most preferably in the range from 62 to 66° C.

The polypropylene composition (PC) preferably has a heat deflection temperature B (HDT-B), determined according to ISO 75B with a load of 0.45 MPa, in the range from 112 to 125° C., more preferably in the range from 114 to 123° C., most preferably in the range from 116 to 121° C.

The polypropylene composition (PC) preferably has a Charpy Notched impact strength (NIS) at 23° C., determined according to ISO 179/1cA using 80×10×4 mm³ test bars injection-moulded in line with ISO 19069-2, in the range from 1.0 to 10.0 kJ/m², more preferably in the range from 2.0 to 7.0 kJ/m², most preferably in the range from 3.0 to 5.0 kJ/m².

The polypropylene composition (PC) preferably has a Charpy Unnotched impact strength (UNIS) at 23° C., determined according to ISO 179/1eU using 80×10×4 mm³ test bars injection-moulded in line with ISO 19069-2, in the range from 30 to 80 kJ/m², more preferably in the range from 35 to 70 kJ/m², most preferably in the range from 40 to 60 kJ/m².

The polypropylene composition (PC) preferably has a tensile modulus, determined according to ISO 527-2, in the range from 2400 to 5000 MPa, more preferably in the range from 2600 to 4000 MPa, most preferably in the range from 2800 to 3500 MPa.

The polypropylene composition (PC) preferably has a flexural modulus, determined according to ISO 178 using 80×10×4 mm³ test bars injection-moulded in line with ISO 19069-2, in the range from 2400 to 5000 MPa, more preferably in the range from 2600 to 4000 MPa, most preferably in the range from 2800 to 3500 MPa.

The polypropylene composition (PC) preferably has a content of low boiling substances (LBS), determined by thermo-desorption analysis, in the range from 0 to 50 μg/g, more preferably in the range from 0 to 40 μg/g, most preferably in the range from 0 to 30 μg/g.

The polypropylene composition (PC) preferably has a content of high boiling substances (HBS), determined according to thermo-desorption analysis, in the range from 0 to 350 μg/g, more preferably in the range from 0 to 300 μg/g, most preferably in the range from 0 to 260 μg/g.

The polypropylene composition (PC) preferably has an amount of fogging, determined according to the gravimetric method DI 75201:2011-11, method B, in the range from 0.10 to 1.50 mg, more preferably in the range from 0.50 to 1.40 mg, most preferably in the range from 0.80 to 1.30 mg.

The polypropylene composition (PC) preferably has a total volatile organic compounds content (TVOC), determined according to VDA 277 January 1995, in the range from 4.0 to 18.0 μgC/g, more preferably in the range from 6.0 to 16.0 μgC/g, most preferably in the range from 8.0 to 14.0 μgC/g.

### The Article

In another aspect, the present invention is directed to an article, preferably an injection-moulded article, comprising the polypropylene composition according to any one of the preceding claims in an amount of at least 95 wt.-%, more preferably at least 98 wt.-%, most preferably at least 99 wt.-%.

Preferably, the article, more preferably the injection-moulded article, is an automotive under-the-bonnet article, more preferably selected from the group consisting of housings for heating, ventilation and air-conditioning.

### EXAMPLES

### 1. Measurement Methods

The following definitions of terms and determination methods apply for the above general description of the invention including the claims as well as to the below examples unless otherwise defined.

### Quantification of Microstructure by NMR Spectroscopy

Quantitative nuclear-magnetic resonance (NMR) spectroscopy was used to quantify the isotacticity of the polymers.

Quantitative 13C {1H} NMR spectra recorded in the solution-state using a Bruker Avance III 400 NMR spectrometer operating at 400.15 and 100.62 MHz for 1H and 13C respectively. All spectra were recorded using a 13C optimised 10 mm selective excitation probehead at 125° C. using nitrogen gas for all pneumatics. Approximately 200 mg of material was dissolved in approximately 3 ml of 1,2-tetrachloroethane-d2 (TCE-d2) along with approximately 3 mg BHT (2,6-di-tert-butyl-4-methylphenol CAS 128-37-0). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution needed for tacticity distribution quantification {busico01, busico97}. Standard single-pulse excitation was employed utilising the NOE, 3 s recycle delay and bi-level WALTZ16 decoupling scheme {zhou07,busico07}. A total of 8192 (8 k) transients were acquired per spectra.

13C {1H} NMR spectra were processed, integrated and relevant quantitative properties determined from the integrals using proprietary computer programs. All chemical shifts were internally referenced to the methyl signal of the isotactic pentad mmmm at 21.85 ppm.

The tacticity distribution was quantified through integration of the methyl region between 23.6 and 19.7 ppm correcting for any sites not related to the stereo sequences of interest {busico01, busico97}.

Characteristic signals corresponding to the presence of regio defects {resconi00} were not observed.

The pentad tacticity distribution was determined through direct separate integration of each methyl signal from a given steric pentad followed by normalisation to the sum of methyl signals from all steric pentads. The relative content of a specific steric pentad was reported as the mole fraction or percentage of a given steric pentad xxxx with respect to all steric pentads:

[xxxx]=xxxx/(mmmm+mmmr+rmmr+mmrr+xmrx+mrmr+rrrr+mrrr+mrrm)

where xmrx represents the combined integral of both mmrm and rmrr as signal from these steric pentads are not commonly resolved. The pentad isotacticity was thus given by:

[mmmm]=mmmm/(mmmm+mmmr+rmmr+mmrr+xmrx+mrmr+rrrr+mrrr+mrrm)
busico01 Busico, V., Cipullo, R., Prog. Polym. Sci. 26 (2001) 443
busico97 Busico, V., Cipullo, R., Monaco, G., Vacatello, M., Segre, A. L., Macromolecules 30 (1997) 6251
zhou07 Zhou, Z., Kuemmerle, R., Qiu, X., Redwine, D., Cong, R., Taha, A., Baugh, D. Winniford, B., J. Mag. Reson. 187 (2007) 225
busico07 Busico, V., Carbonniere, P., Cipullo, R., Pellecchia, R., Severn, J., Talarico, G., Macromol. Rapid Commun. 2007, 28, 1128
resconi00 Resconi, L., Cavallo, L., Fait, A., Picmontesi, F., Chem. Rev. 2000, 100, 1253

### CRYSTEX QC Analysis

### Crystalline and Soluble Fractions Method

The crystalline (CF) and soluble fractions (SF) of the polypropylene (PP) compositions as well as the comonomer content and intrinsic viscosities of the respective fractions were analysed by use of the CRYSTEX instrument, Polymer Char (Valencia, Spain). Details of the technique and the method can be found in literature (Ljiljana Jeremic, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596)

The crystalline and amorphous fractions are separated through temperature cycles of dissolution at 160° C., crystallization at 40° C. and re-dissolution in 1,2,4-trichlorobenzene at 160° C. Quantification of SF and CF and determination of ethylene content (C2) are achieved by means of an integrated infrared detector (IR4) and for the determination of the intrinsic viscosity (IV) an online 2-capillary viscometer is used.

The IR4 detector is a multiple wavelength detector measuring IR absorbance at two different bands (CH₃ stretching vibration (centred at app. 2960 cm-1) and the CH stretching vibration (2700-3000 cm-1) that are serving for the determination of the concentration and the Ethylene content in Ethylene-Propylene copolymers. The IR4 detector is calibrated with series of 8 EP copolymers with known Ethylene content in the range of 2 wt.-% to 69 wt.-% (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

$$Conc = a + b * Abs ( CH ) + c * {( Abs ( CH ) )}^{2} + d * Abs ( {CH}_{3} ) + e * ( {Abs ( {CH}_{3} )}^{2} + f * Abs ( CH ) * Abs ( {CH}_{3} ) \qquad ( Equation 1 )$$

$${CH}_{3} / 1000 C = a + b * Abs ( CH ) + c * Abs ( {CH}_{3} ) + d * ( Abs ( {CH}_{3} ) / Abs ( CH ) ) + e * {( Abs ( {CH}_{3} ) / Abs ( CH ) )}^{2} \qquad ( Equation 2 )$$

The constants a to e for equation 1 and a to f for equation 2 were determined by using least square regression analysis.

The CH₃/1000C is converted to the ethylene content in wt.-% using following relationship:

$$Wt . - \% ( Ethylene in EP Copolymers ) = 100 - {CH}_{3} / 1000 TC * 0.3 \qquad ( Equation 3 )$$

Amounts of Soluble Fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per ISO16152. XS calibration is achieved by testing various EP copolymers with XS content in the range 2-31 wt.-%. The determined XS calibration is linear:

$$Wt . - \% XS = 1.01 * Wt . - \% SF \qquad ( Equation 4 )$$

Intrinsic viscosity (IV) of the parent EP copolymer and its soluble and crystalline fractions are determined with a use of an online 2-capillary viscometer and are correlated to corresponding IV's determined by standard method in decalin according to ISO 1628-3. Calibration is achieved with various EP PP copolymers with IV=2-4 dL/g. The determined calibration curve is linear:

$$IV ( dL / g ) = a * Vsp / c \qquad ( equation 5 )$$

The samples to be analysed are weighed out in concentrations of 10 mg/ml to 20 mg/ml. To avoid injecting possible gels and/or polymers which do not dissolve in TCB at 160° C., like PET and PA, the weighed out sample was packed into a stainless steel mesh MW 0.077/D 0.05 mmm.

After automated filling of the vial with 1,2,4-TCB containing 250 mg/l 2,6-tert-butyl-4-methylphenol (BHT) as antioxidant, the sample is dissolved at 160° C. until complete dissolution is achieved, usually for 60 min, with constant stirring of 400 rpm. To avoid sample degradation, the polymer solution is blanketed with the N2 atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the IV [dl/g] and the C2 [wt.-%] of the PP composition. During the second injection the soluble fraction (at low temperature) and the crystalline fraction (at high temperature) with the crystallization cycle are measured (wt.-% SF, wt.-% C2, IV).

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR₂ of polypropylene is determined at a temperature of 230° C. and a load of 2.16 kg.

### Density:

The density is measured according to ISO 1183-187. Sample preparation is done by compression moulding in accordance with ISO 1872-2:2007.

The xylene soluble fraction at room temperature (XCS, wt.-%): The amount of the polymer soluble in xylene is determined at 25° C. according to ISO 16152; 5th edition; 2005 Jul. 1.

DSC analysis, melting temperature (Tₘ) and heat of fusion (H_{f}), crystallization temperature (T_{c}) and heat of crystallization (H_{c}): measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C. Crystallization temperature (T_{c}) and crystallization enthalpy (H_{c}) are determined from the cooling step, while melting temperature (Tₘ) and melting enthalpy (Hm) are determined from the second heating step.

### Flexural Modulus, Flexural Strength

The Flexural properties are determined according to ISO 178 method A (3-point bonding test) on 80 mm×10 mm×4 mm specimens. Following the standard, a test speed of 2 mm/min and a span length of 16 times the thickness was used. The testing temperature was 23=2° C. Injection moulding was carried out according to ISO 19069-2 using a melt temperature of 240° C. for all materials irrespective of material melt flow rate.

Tensile Modulus, Tensile Strength, Tensile Strain, Tensile Stress The tensile properties are determined on injection moulded dogbone specimens prepared in accordance with ISO 527-2. Tensile modulus was determined according to ISO 527-1,-2 at 1 mm/min, and 23° C. To determine stress at yield and strain at yield, a speed of 50 mm/min. was used.

### Notched Impact Strength (NIS)

The Charpy notched impact strength (NIS) is measured according to ISO 179 1eA at +23° C. or −20° C., using injection moulded bar test specimens of 80×10×4 mm³ prepared in accordance with ISO 19069-2 using a melt temperature of 240° C. for all materials irrespective of material melt flow rate.

### Unnotched Impact Strength (UNIS)

The Charpy unnotched impact strength (UNIS) is measured according to ISO 179 1cU at +23° C. or −20° C., using injection moulded bar test specimens of 80×10×4 mm³ prepared in accordance with ISO 19069-2 using a melt temperature of 240° C. for all materials irrespective of material melt flow rate.

### Heat Deflection Temperature (HDT):

The heat deflection temperature is measured on using injection moulded bar test specimens of 80×10×4 mm³ prepared in accordance with ISO 19069-2 using a melt temperature of 240° C. for all materials irrespective of material melt flow rate. The injection moulded specimens are placed in a heating bath. The specimens were loaded in a three point bending set-up aiming for an outer fiber stress of 0.45 MPa or 1.82 MPa. The temperature of the bath is raised at a constant heating rate of 120° C./h until an outer fiber strain reaches 0.2%. The temperature at which this level of deformation is reached is the heat deflection temperature of the material.

### Vicat Softening Temperature (Method B-50)

The Vicat softening temperature (VST) test was conducted according to ISO 306 method B using a load of 50 N and a heating rate of 50° C./h. The test specimens had a dimension of 10 mm×10 mm×4 mm. Test specimens were milled from injection moulded bar test specimens of 80×10×4 mm³ prepared in accordance with ISO 19069-2 using a melt temperature of 240° C. for all materials irrespective of material melt flow rate.

Average Particle Size (Diameter) d₅₀ and Top Cut d₉₈

The particle size definitions are calculated from the particle size distribution [mass percent] as determined by laser diffraction method, using Laser Mastersizer, according to ISO 13320-1. The d₅₀ is defined as the median diameter, whilst dos is the diameter at the 98th percentile, as observed from the particle size distribution.

### Inorganic Residues

Inorganic residues are quantified according to DIN ISO 1172:1996 using a Perkin Elmer TGA 8000. Approximately 10-20 mg of material was placed in a platinum pan. The temperature was equilibrated at 50° C. for 10 minutes, and afterwards raised to 950° C. under nitrogen at a heating rate of 20° C./min. The ash content was evaluated as the weight % at 850° C.

### Black Spot Quantification (Amount of Defects Having Certain Particle Sizes)

Digital images of 5 injection moulded plaques were collected with a Canon EOS R6 camera. Settings were fixed such that a resolution of about 15 pixel/mm were obtained. Once the image had been converted to grey scale and the intensity normalized between 0 and 256, the exposure time was fixed such that a grey level of ca. 160 was obtained for the plaques. Image analysis was performed with the Wavemetrics IgorPro software. A Region of Interest area was fixed inside the plaques, with size of 2100×1125 pixels². A Prewitt edge detection algorithm, set with threshold of 10, was used to identify the particles on the surface. The edge image was then analysed to gather information about the number and size of particles detected, with a minimum area of 5 pixels and excluding particles touching the border of the area analysed. This operation was repeated for the 5 plaques imaged, and a size distribution of particles was created. The number of particles was normalized by the total area imaged in the 5 plaques, and therefore a frequency of particles as #/cm² was obtained. The particles were grouped in bins according to their size, with bin size of 0.05 mm².

### CIELAB Colour Space (L*a*b*)

In the CIE L*a*b* uniform colour space, the colour coordinates are: L*—the lightness coordinate; a*—the red/green coordinate, with +a* indicating red, and −a* indicating green; and b*—the yellow/blue coordinate, with +b* indicating yellow, and −b* indicating blue.

The L*, a*, and b*coordinate axis define the three dimensional CIE colour space. The CIELAB values are determined according to ISO 11664-4, using as apparatus a Spectrophotomer Datacolor 800.

### Limonene Detection

The determination of limonene is based on a static headspace (HS) approach. This analysis uses a combination of a HS sampler with a gas chromatograph (GC) and a mass spectrometer (MS) for screening purposes.

Samples were delivered to the lab in sealed aluminium-coated polyethylene (PE) bags. Prior to the analysis, samples were cryo-milled, a portion of 2.000±0.100 g was weighed in a 20 ml HS vial and tightly closed. For every sample, a double determination was performed.

### HS/GC/MS Parameters

HS parameters (Agilent G1888 Headspace Sampler)

| | |
|---|---|
| Vial equilibration time: | 120 min (sample), 5 min (standard) |
| Oven temperature: | 100° C. (samplc), 200° C. (standard) |
| Loop temperature: | 110° C. (sample), 205° C. (standard) |
| Transfer line temperature: | 120° C. (sample), 210° C. (standard) |
| Low shaking | |

GC parameters (Agilent 7890A GC System)

| | |
|---|---|
| Column: | ZB-WAX 7HG-G007-22 |
| (30 m × 250 μm × 1 μm) | |
| Carrier gas: | Helium 5.0 |
| Flow: | 2 ml/min |
| Split: | 5:1 |
| GC oven program: | 35° C. for 0.1 min |
| | 10° C./min until 250° C. |
| | 250° C. for 1 min |

MS parameters (Agilent 5975C inert XL MSD)

| Acquisition mode: | | Scan |
|---|---|---|
| Scan parameters: | Low mass: | 20 |
| | High mass: | 200 |
| | Threshold: | 10 |

Software/Data evaluation
   MSD ChemStation E.02.02.1431
   MassHunter GC/MS Acquisition B.07.05.2479
   AMDIS GC/MS Analysis Version 2.71
   NIST/EPA/NIH Mass Spectral Library (2011 version)
   NIST Mass Spectral Search Program Version 2.0 g
AMDIS deconvolution parameters

| | |
|---|---|
| Minimum match factor: | 80 |
| Threshold: | Low |
| Scan direction: | High to Low |
| Data file format: | Agilent files |
| Instrument type: | Quadrupole |
| Component width: | 20 |
| Adjacent peak subtraction: | Two |
| Resolution: | High |
| Sensitivity: | Very high |
| Shape requirements: | Medium |
| Solvent tailing: | 91 m/z |
| Column bleed: | 207 m/z |
| Min. model peaks: | 2 |
| Min. S/N: | 10 |
| Min. certain peaks: | 0.5 |

MSD ChemStation integration parameters

| Integrator: | ChemStation |
|---|---|
| Initial area reject: | 0 |
| Initial peak width: | 0.005 |
| Shoulder detection: | off |
| Initial threshold: | 10.5 |

In this study, the statement “below the limit of detection (<LOD)” describes a condition where either the match factor is below 80 (AMDIS) or the signal to noise ratio (Pk-pk S/N=Corrected signal/Pk-pk noise, MSD ChemStation signal to noise report) of the peak in the sample run is below 3. The results refer solely to the measured samples, time of measurement and the applied parameters.

### Standard Solutions

For a positive identification and comparison with the (lowest) odour detection thresholds (ODT), a limonene standard was used.

For the HS/GC/MS analysis, 5 μl of the respective standard was injected in a 20 ml HS vial, tightly closed and measured.

Assuming full vaporisation of the standard substance, the concentration limonene in the HS c_{G} was estimated as listed in Table 1.

TABLE 1
Calibration standard and ODT

| | | c_{G}/mg | Target | (lowest) ODT/ |
|---|---|---|---|---|
| Analyte | Solvent | m⁻³ | ion (m/z) | mg m⁻³ [1] |
| Limonene | 2-Butanol | 75 | 68 | 0.21 |

### Data Evaluation

The concentration of an analyte in the HS c_{G} is calculated by considering the substance amount m_{G} and the available HS volume V_{G} (Equation 1).

$${c}_{G}^{Standard} [ mg / {m}^{3} ] = \frac{{m}_{G}^{Standard}}{{V}_{G}^{Standard}} \qquad Equation 1$$

To estimate the concentration of an analyte in the HS above a polymer sample, the response factor, Rf of a one-point calibration is required (Equation 2). By integrating the extracted ion chromatogram (EIC), the peak area is obtained for the analyte. The corresponding target ion is listed in Table 1.

$$Rf = \frac{{c}_{G}^{Standard}}{Peak {area}^{Standard}} \qquad Equation 2$$

The concentration of an analyte in the HS above a polymer sample,

$${c}_{G}^{Sample}$$

is calculated by multiplying the response factor with the EIC peak area of the sample (Equation 3).

$${c}_{G}^{Sample} [ mg / {m}^{3} ] = R f * {area}^{Sample} \qquad Equation 3$$

Additionally, the odour relevance of an analyte in the HS above a polymer sample is estimated by the odour activity value (OAV). Therefore, the concentration of an analyte in the HS above a polymer sample

$${c}_{G}^{Sample}$$

is compared with the (lowest) odour detection threshold (ODT) found in literature (Equation 4) [1]. A value above 1 indicates the relevance of an analyte to the odour at the given HS temperature.

$$OAV = \frac{{c}_{G}^{Sample} [ mg / {m}^{3} ]}{ODT [ mg / {m}^{3} ]} \qquad Equation 4$$

### Considerations and Limitations

It must be considered that the ODT for some substances is below the detection limit (LOD) of the method. Therefore, components below the LOD might be missed although still relevant to the overall odour.

The OAV is based on the assumption that the HS parameters are somewhat relatable to the measurement conditions of an ODT determination. Of course, this is not fully applicable because temperature settings of 100° C. are not necessarily chosen for such experiments and have therefore limited practical value. Nevertheless, this approach can at least indicate the odour relevance of the defined marker substances.

### REFERENCES

[1] Van Gemert L. J., Odour Thresholds: Compilations of odour threshold values in air, water and other media, Utrecht, Oliemans Punter & Partners BV, 2011.

### Total Free Fatty Acid Content

Fatty acid quantification was carried out using headspace solid phase micro-extraction (HS-SPME-GC-MS) by standard addition.

50 mg ground samples were weighed in 20 mL headspace vial and after the addition of limonene in different concentrations and a glass coated magnetic stir bar the vial was closed with a magnetic cap lined with silicone/PTFE. 10 μL Micro-capillaries were used to add diluted free fatty acid mix (acetic acid, propionic acid, butyric acid, pentanoic acid, hexanoic acid and octanoic acid) standards of known concentrations to the sample at three different levels. Addition of 0, 50, 100 and 500 ng equals 0 mg/kg, 1 mg/kg, 2 mg/kg and 10 mg/kg of each individual acid. For quantification ion 60 acquired in SIM mode was used for all acids except propanoic acid, here ion 74 was used.

### GCMS Parameter:

Column: 20 m ZB Wax plus 0.25*0.25
Injector: Split 5:1 with glass lined split liner, 250° C.
Temperature program: 40° C. (1 min) @6° C./min to 120° C., @15° C. to 245° C. (5 min)
Carrier: Helium 5.0, 40 cm/s linear velocity, constant flow
MS: Single quadrupole, direct interface, 220° C. inter face temperature
Acquisition: SIM scan mode
Scan parameter: 46-250 amu 6.6 scans/s
SIM Parameter: m/z 60, 74, 6.6 scans/s

### Fogging

Fogging was measured according to ISO 75201:2011-11, method B (gravimetric method) on compression-moulded specimens (diameter 80 mm+/−1 mm, thickness 2 mm) cut out from an injection moulded plate. With this method, the mass of fogging condensate on aluminium foil in mg by means weighing of foil before and after the fogging test is determined. The term “fogging” refers to a fraction of volatile substances condensed on glass parts as e.g. the windscreen of a vehicle.

### Screening of Organic Emissions by Thermo-Desorption Analysis

This method describes the semi-quantitative determination of organic compounds emitting from polyolefins. It is similar to the VDA 278 (October 2011) but includes specific adjustments. Directly after the production the sample (injection moulded plaque, DIN-A5) is sealed in an aluminium-coated polyethylene bag and provided to the lab within 14 days. In the lab, it is stored openly for 7 days below 25° C. After this period, an aliquot of 60±5 mg is prepared from the stored sample. Trimming the aliquot should aim for a maximum coherent area. It is not the aim to create the largest possible surface area by cutting the aliquot into smaller pieces. The diameter of the sample injection tube should be used first. Length and thickness should be chosen accordingly, considering the specified aliquot weight. The aliquot is directly desorbed using heat and a flow of helium gas. Volatile and semi-volatile organic compounds are extracted into the gas stream and cryo-focused prior to the injection into a gas chromatographic (GC) system for analysis. The method comprises two extraction stages: In the analysis of low-boiling substances (LBS) the aliquot is desorbed at 90° C. for 30 min to determine volatile organic compounds in the boiling/elution range up to n-C25 (n-pentacosane). The analysis of high-boiling substances (HBS) involves a further desorption step of the same aliquot at 120° C. for 60 min to determine semi-volatile compounds in the boiling/elution range from n-C14 (n-tetradecane) to n-C32 (n-dotriacontane).

Similar to the VOC and FOG value in the VDA 278, the LBS is calculated as toluene equivalent (TE) and the HBS is calculated as hexadecane equivalent (HE) applying a semi-quantitation and a respective calibration. The result is expressed in “μg/g”.

Integration parameters for the LBS and HBS evaluation are chosen in such way that the “area reject” corresponds to the area of 1 μg/g (TE and HE, respectively). Thus, smaller peaks do not add to the semi-quantitative result. The GC oven program is kept the same, no matter if a calibration run, an LBS run or an HBS run was performed. It starts at 50° C. (1 min hold), followed by a ramp of 10° C./min and an end temperature of 320° C. (10 min hold). For the GC column an Agilent DB5: 50 m×250 μm×0.25 μm (or comparable) is used. The method requires a Thermal Desorption System TDS 3 (Gerstel) and a Cooled Injection System CIS 4 (Gerstel) as well as a GC system with a flame ionisation detector (FID) but does not involve a mass spectrometer. Instead of 280° C. the CIS end temperature is always set to 380° C.

### Total Volume of Organic Compounds (TVOC):

The TVOC value (also known as total carbon emission) is determined according to VDA 277 January 1995.

Amount of iPP, Polystyrene, Polyethylene (and Ethylene Containing Copolymers), Poly(Ethylene Terephthalate), and Amount of Polyamide-6

Calibration standards are prepared by blending iPP and HDPE to create a calibration curve. The thickness of the films of the calibration standards are 300 μm. For the quantification of the iPP, PS and PA 6 content in the samples quantitative IR spectra are recorded in the solid-state using a Bruker Vertex 70 FTIR spectrometer. Spectra are recorded on 25×25 mm square films of 50-100 μm thickness prepared by compression moulding at 190° C. and 4-6 mPa. Standard transmission FTIR spectroscopy is employed using a spectral range of 4000-400 cm⁻¹, an aperture of 6 mm, a spectral resolution of 2 cm⁻¹, 16 background scans, 16 spectrum scans, an interferogram zero filling factor of 32 and Norton Beer strong apodisation.

The absorption of the band at 1167 cm⁻¹ in iPP is measured and the iPP content is quantified according to a calibration curve (absorption/thickness in cm versus iPP content in weight %). The absorption of the band at 1601 cm⁻¹ (PS), at 1513 cm⁻¹ (PET) and 3300 cm⁻¹ (PA6) are measured and the PS, PET and PA6 content quantified according to the calibration curve (absorption/thickness in cm versus PS, PET and PA content in wt.-%). The content of polyethylene and ethylene containing copolymers is obtained by subtracting (iPP+PS+PET+PA6) from 100, taking into account the content of non-polymeric impurities as determined in the methods below. The analysis is performed as double determination.

### 2. Examples

### 2.1 Synthesis of Heterophasic Propylene-Ethylene Copolymer (HECO)

The catalyst used in the polymerization processes was the commercial ZN180 of Basell with triethyl-aluminium (TEAl) as co-catalyst and dicyclo pentyl dimethoxy silane (donor D) as donor. The Al/donor ratio was 5 mol/mol, and the Al/Ti ratio was 200 mol/mol. A Borstar PP pilot plant comprised of a stirred-tank prepolymerization reactor (R1), a liquid-bulk loop reactor (R2) and two gas phase reactors (R3 and R4) was used for the main polymerization.

The subsequent polymerization has been effected under the following conditions.

TABLE 1
Polymerization conditions for the HECO

HECO

Prepolymerization (R1)

| | | |
|---|---|---|
| [Co]/[ED] | [mol/mol] | 5 |
| [Co]/[Ti] | [mol/mol] | 200 |
| Temperature | [° C.] | 28 |
| Residence time | [min] | 0.4 |

Loop reactor (R2)

| | | |
|---|---|---|
| Temperaturc | [° C.] | 70 |
| Split | [wt.-%] | 53.8 |
| H2/C3 | [kg/ton] | 3.22 |
| MFR₂ | [g/10 min] | 28.8 |

1^{st} Gas phase reactor (R3)

| | | |
|---|---|---|
| Temperature | [° C.] | 80 |
| Split | [wt.-%] | 46.2 |
| H2/C3 | [mol/kmol] | 31.15 |
| MFR₂ | [g/10 min] | 29.9 |
| XCS | [wt.-%] | 2.8 |

2^{nd} Gas phase reactor (R4)

| | | |
|---|---|---|
| Temperature | [° C.] | 75 |
| Split | [wt.-%] | 0.45 |
| H2/C2 | [mol/kmol] | 109.6 |
| C2/C3 | [mol/kmol] | 468 |
| MFR₂ | [g/10 min] | 25 |
| C2 | [wt.-%] | 2.60 |

Final Properties (pellet)

| | | |
|---|---|---|
| MFR₂ | [g/10 min] | 22 |
| C2(total) | [wt.-%] | 2.8 |
| SF | [wt.-%] | 7.0 |
| C2(SF) | [wt.-%] | 21.0 |
| iV(SF) | [dL/g] | 1.32 |
| CF | [wt.-%] | 93.0 |
| C2(CF) | [wt.-%] | 1.2 |
| iV(CF) | [dL/g] | 1.60 |

The heterophasic copolymer HECO was compounded in a co-rotating twin-screw extruder Coperion ZSK 47 at 220° C. with 0.17 wt.-% Irganox 1010 (CAS-no. 6683-19-8, commercially available from BASF AG (Germany)), 0.15 wt.-% Irgafos 168 (CAS-no. 31570-04-4, commercially available from BASF AG (Germany)), calcium stearate (CAS-no. 216-472-8, commercially available from Faci (Italy)) and 2.5 wt.-% of talc with the trade name Plustalc H10 from Mondo Minerals.

### 2.2 Mixed-Plastic Polypropylene Blend (B1)

The properties of the mixed-plastic polypropylene blend (B1) are given in Table 2, along with the properties of a comparative mixed-plastic polypropylene blend (B2). B1 originates from post-consumer waste, whilst B2 originates from post-industrial waste. B3 and B4 are also post-consumer recyclates with considerably higher C2 content than B1, as well as higher defect contents.

TABLE 2
Properties of mixed-plastic polypropylene
blends (B1 and B2)

| | | B1 | B2 | B3 | B4 |
|---|---|---|---|---|---|
| density | [kg/m³] | 917 | 984 | 919 | 946 |
| MFR₂ | [g/10 min] | 25 | 27 | 14 | 8 |
| C2(total) | [wt.-%] | 5.4 | 0 | 11.7 | 45.0 |
| SF | [wt.-%] | 11.0 | 3.0 | 9.8 | 9.0 |
| C2(SF) | [wt.-%] | 27.7 | 0 | 29.3 | 45.0 |
| iV(SF) | [dL/g] | 1.71 | n.m. | 1.26 | 1.25 |
| CF | [wt.-%] | 89.0 | 97.0 | 90.2 | 91.0 |
| C2(CF) | [wt.-%] | 3.2 | 0 | 10.3 | 47.0 |
| iV(CF) | [dL/g] | 1.55 | 1.58 | 1.71 | 1.90 |
| Content | [particles/ | 0.4 | 0.0 | 2.2 | 3.5 |
| of defects | cm²] | | | | |
| Inorganic | [wt.-%] | 1.21 | 9.5 | 1.4 | 1.3 |
| residues | | | | | |
| Flexural | [MPa] | 1344 | 2122 | 1236 | 750 |
| Modulus | | | | | |
| Charpy NIS | [kJ/m²] | 5.14 | 2.06 | 5.8 | 7.0 |
| (23° C.) | | | | | |
| CIELAB, L* | [-] | 46 | n.m. | n.m. | n.m. |
| CIELAB, a* | [-] | −2.77 | n.m. | n.m. | n.m. |
| CIELAB, b* | [-] | −0.57 | n.m. | n.m. | n.m. |

B1, being a post-consumer recyclate, further comprises minor amounts of polystyrene, polyamide-6, limonene and fatty acids. The pellets of B1 were aerated before use, to remove volatile organic components as described in EP 3 786 190 A1.
B2, being a post-industrial recyclate, does not comprise polystyrene, polyamide-6, limonene and/or fatty acids. B2 does, however, comprise 9.5 wt.-% of talc.
B3 is Dipolen PP, a post-consumer recyclate available from Borealis AG (Austria).
B4 is Dipolen S, a post-consumer recyclate available from Borealis AG (Austria).

### 2.3 Compounding of Inventive and Comparative Compositions

The inventive and comparative compositions were prepared based on the recipes indicated in Table 3 by compounding in a co-rotating twin-screw extruder Coperion ZSK 40 at 220° C.

TABLE 3
Recipes for inventive and comparative examples

| | | CE1 | CE2 | IE1 | IE2 | IE3 | CE3 | CE4 |
|---|---|---|---|---|---|---|---|---|
| HECO | [wt.-%] | 68.40 | 44.25 | 35.50 | 21.50 | 16.50 | 21.50 | 21.50 |
| h-PP | [wt.-%] | 10.00 | — | 7.00 | 5.00 | 10.00 | 5.00 | 5.00 |
| B1 | [wt.-%] | — | — | 35.00 | 50.00 | 50.00 | — | — |
| B2 | [wt.-%] | — | 39.00 | — | — | — | — | — |
| B3 | [wt.-%] | — | — | — | — | — | 50.00 | — |
| B4 | [wt.-%] | — | — | — | — | — | — | 50.00 |
| F1 | [wt.-%] | — | 15.20 | 19.00 | 20.00 | 20.00 | 20.00 | 20.00 |
| F2 | [wt.-%] | 18.30 | — | — | — | — | — | — |
| Black | [wt.-%] | 1.00 | 0.70 | 1.50 | 1.50 | 1.50 | 1.50 | 1.50 |
| MB | | | | | | | | |
| MB | [wt.-%] | 1.15 | — | 1.50 | 1.50 | 1.50 | 1.50 | 1.50 |
| carrier | | | | | | | | |
| AA | [wt.-%] | 0.10 | 0.10 | 0.10 | 0.10 | 0.10 | 0.10 | 0.10 |
| AO1 | [wt.-%] | 0.25 | 0.25 | 0.25 | 0.25 | 0.25 | 0.25 | 0.25 |
| AO2 | [wt.-%] | 0.10 | 0.10 | 0.10 | 0.10 | 0.10 | 0.10 | 0.10 |
| AO3 | [wt.-%] | 0.30 | 0.30 | 0.30 | 0.30 | 0.30 | 0.30 | 0.30 |

In addition to the HECO and the mixed-plastic polypropylene blends described above, the following commercially available components were also employed:
h-PP a commercial propylene homopolymer HJ120UB, commercially available from Borealis AG (Austria), having MFR₂ (230° C.) of 75 g/10 min, an XCS of 3.0 wt.-%, and a Tₘ of 165° C. HJ120UB is produced using a Ziegler-Natta catalyst and is thus free from 2,1-regiodefects.
F1 talc with a trade name of CHX05L commercially available from IMI Fabi (Italy), with median diameter d₅₀ of 0.6 μm and top cut diameter d₉₈ of 6.2 μm, determined according to laser diffraction.
F2 talc with a trade name of Finntalc M15, commercially available from Elementis (Germany), with median diameter d₅₀ of 4.5 μm and top cut diameter d₉₈ of 17 μm, determined according to Sedigraph analysis.
Black MB a polyethylene based masterbatch CBMB LD-09 A02 from Borealis AG (Norway) containing 40 wt.-% of pigment.
Masterbatch carrier a carrier propylene homopolymer with a trade name of HC001 A, commercially available from Borealis AG (Austria).
AA Antistatic agent being a glycerol monostearate with a trade name of Dimodan HP MB, commercially available from Danisco (Denmark).
AO1 antioxidant with a trade name of Irganox 1010 (CAS-no. 6683-19-8), commercially available from BASF AG (Germany).
AO2 antioxidant with a trade name of Irgafos 168 (CAS-no. 31570-04-4), commercially available from BASF AG (Germany).
AO3 antioxidant with a trade name Irganox PS-802 FL (CAS-no. 123-28-4), commercially available from BASF AG (Germany).

The properties of the inventive and comparative compositions are given in Table 4.

TABLE 4
Properties of the inventive and comparative compositions

| | | CE1 | CE2 | IE1 | IE2 | IE3 | CE3 | CE4 |
|---|---|---|---|---|---|---|---|---|
| MFR₂ | [g/10 min] | 22.0 | 23.4 | 23.5 | 23.6 | 23.8 | 16.0 | 8.4 |
| C2(total) | [wt.-%] | 1.8 | 1.4 | 3.9 | 4.3 | 4.8 | 8.2 | 28 |
| iV(total) | [dL/g] | 1.57 | 1.51 | 1.51 | 1.52 | 1.49 | 1.65 | 1.72 |
| SF | [wt.-%] | 8 | 7 | 10 | 11 | 11 | 9 | 8 |
| C2(SF) | [wt.-%] | 19 | 16 | 22 | 23 | 27 | 23 | 28 |
| iV(SF) | [dL/g] | 1.15 | 0.70 | 1.35 | 1.39 | 1.40 | 1.19 | 1.07 |
| CF | [wt.-%] | 92 | 93 | 90 | 89 | 89 | 91 | 92 |
| C2(CF) | [wt.-%] | 1.2 | 1.6 | 2.8 | 3.0 | 2.9 | 6.8 | 28 |
| iV(CF) | [dL/g] | 1.63 | 1.55 | 1.53 | 1.58 | 1.57 | 1.69 | 1.77 |
| Density | [kg/m³] | 1060 | 1053 | 1058 | 1065 | 1063 | n.m. | n.m. |
| Inorganic residues | [wt.-%] | 18.0 | 18.1 | 19.9 | 20.3 | 20.3 | 20.0 | 19.8 |
| HDT A (1.82 MPa) | [° C.] | 65 | 63 | 65 | 63 | 64 | n.m. | n.m. |
| HDT B (0.45 MPa) | [° C.] | 126 | 120 | 120 | 118 | 117 | 115 | 98 |
| Vicat temperature | [° C.] | n.m. | n.m. | n.m. | 86 | n.m. | 82 | 71 |
| Flexural Modulus | [MPa] | 3130 | 2890 | 2880 | 2830 | 2840 | 2590 | 2120 |
| Flexural Strength | [MPa] | 51 | 46 | 46 | 44 | 45 | 40 | 33 |
| NIS (23° C.) | [KJ/m²] | 2.10 | 2.30 | 3.24 | 3.56 | 3.35 | 3.66 | 3.85 |
| UNIS (23° C.) | [KJ/m²] | 38.6 | 37.5 | 49.2 | 44.2 | 42.9 | 43.4 | 39.2 |
| Tens Modulus | [MPa] | 3090 | 2890 | 2890 | 2790 | 2790 | 2490 | 2000 |
| Tens Strength | [MPa] | 33.7 | 33.5 | 31.0 | 29.9 | 29.9 | 28.8 | 25.3 |
| Tens Stress@yield | [MPa] | 33.7 | 33.5 | 31.0 | 30.0 | 30.0 | 28.8 | 25.3 |
| Fogging grav. | [mg] | 0.91 | 0.81 | 0.99 | 1.15 | 1.15 | 2.31 | 2.72 |
| TVOC | [μgC/g] | 19 | 19 | 13 | 10 | 12 | 9 | 6 |
| HBS | [μg/g] | 188 | 235 | 242 | 251 | 224 | 295 | 375 |
| LBS | [μg/g] | 23 | 24 | 37 | 25 | 27 | 24 | 26 |

As can be seen from Table 4, the inventive examples IE1 to IE3 have an excellent balance of mechanical properties, comparable to those of the composition formed from only virgin polymers (CE1) and the composition comprising post-industrial recyclate (CE2). IE1 has a similar level of recyclate to CE2 (note: B2 contains 9.5 wt.-% talc, thus the content of recycled polymer in CE2 is approx. 35 wt.-%) with very similar properties, both in terms of mechanical properties and HBS/LBS values. Furthermore, even higher levels of post-consumer recyclate (i.e. 50 wt.-%) are incorporated in IE2 and IE3, reducing the content of virgin material to approx. 25 wt.-%, without a noticeable decrease in the mechanical/odor properties. Indeed, IE1 to IE3 in fact display improved TVOC values, relative to CE1 and CE2, which is an extremely surprising effect. The impact strengths (NIS and UNIS) of IE1 to IE3 are also improved, relative to CE1 and CE2. Relative to CE3 and CE4, which use alternative post-consumer recyclates, IE1 to IE3 have improved HDT B, improved Vicat softening temperature, improved Flexural Modulus, improved Tensile Modulus, and improved fogging gravimetric.

1. A polypropylene composition (PC) being a mixed-plastic polypropylene blend, being obtainable by blending at least components a) to e):
a) from 15.0 to 40.0 wt.-%, relative to the total weight of the polypropylene composition (PC), of a heterophasic propylene-ethylene copolymer (HECO) having a melt flow rate (MFR₂), determined according to ISO 1133 at 230° C. and 2.16 kg, in the range from 12 to 70 g/10 min;
b) from 30.0 to 60.0 wt.-%, relative to the total weight of the polypropylene composition (PC), of a mixed-plastic polypropylene blend (B) having a melt flow rate (MFR₂), determined according to ISO 1133 at 230° C. and 2.16 kg, in the range from 16 to 50 g/10 min and an amount of defects with a particle size in the range from 0.05 to 0.10 mm² in the range from 0.1 to 1.0 particles/cm²;
c) from 18.0 to 25.0 wt.-%, relative to the total weight of the polypropylene composition (PC), of an inorganic filler (F);
d) optionally, from 0.0 to 15.0 wt.-%, relative to the total weight of the polypropylene composition (PC), of a propylene homopolymer (h-PP) having a melt flow rate (MFR₂), determined according to ISO 1133 at 230° C. and 2.16 kg, in the range from 50 to 200 g/10 min; and
e) from 0.2 to 5.0 wt.-%, relative to the total weight of the polypropylene composition (PC), of further additive(s) (A),
wherein the total contents of components a) to e) add up to at least 98 wt.-%, relative to the total weight of the polypropylene composition (PC).

2. The polypropylene composition (PC) according to claim 1, having a melt flow rate (MFR₂), determined according to ISO 1133 at 230° C. and 2.16 kg, in the range from 12 to 70 g/10 min.

3. The polypropylene composition (PC) according to claim 1, wherein the heterophasic propylene-ethylene copolymer (HECO) has one or more of the following properties:
a) an ethylene content (C2(total)), determined by CRYSTEX QC analysis, in the range from 1.0 to 6.0 wt.-%;
b) a soluble fraction (SF) content, determined by CRYSTEX QC analysis, in the range from 4.0 to 12.0 wt.-% and a crystalline fraction (CF) content, determined by CRYSTEX QC analysis, in the range from 88.0 to 96.0 wt.-%;
c) an ethylene content of the soluble fraction (C2(SF)), determined by CRYSTEX QC analysis, in the range from 10 to 30 wt.-%;
d) an ethylene content of the crystalline fraction (C2(CF)), determined by CRYSTEX QC analysis, in the range from 0.0 to 3.0 wt.-%;
e) an intrinsic viscosity of the soluble fraction (iV(SF)), determined by CRYSTEX QC analysis, in the range from 1.00 to 2.00 dL/g;
f) an intrinsic viscosity of the crystalline fraction (iV(CF)), determined by CRYSTEX QC analysis, in the range from 1.00 to 2.00 dL/g; and
g) an intrinsic viscosity ratio (iV(SF)/iV(CF)), determined by CRYSTEX QC analysis, in the range from 0.50 to 1.00.

4. The polypropylene composition (PC) according to claim 1, wherein the propylene homopolymer (h-PP) has one or more of the following properties:
a) a xylene cold soluble (XCS) content, determined according to ISO 16152 analysis, in the range from 0.5 to 6.0 wt.-%;
b) a melting temperature (Tm), determined by differential scanning calorimetry (DSC), in the range from 159 to 169° C.; and
c) being free of 2,1-regiodefects, as determined by ¹³C-NMR spectroscopy.

5. The polypropylene composition (PC) according to claim 1, wherein the inorganic filler (F) is talc.

6. The polypropylene composition (PC) according to claim 1, wherein the mixed-plastic polypropylene blend (B) has one or more of the following properties:
a) an ethylene content (C2(total)), determined by CRYSTEX QC analysis, in the range from 2.0 to 10.0 wt.-%;
b) a soluble fraction (SF) content in the range from 5.0 to 20.0 wt.-% and a crystalline fraction (CF) in the range from 80.0 to 95.0 wt.-%, both determined by CRYSTEX QC analysis;
c) an ethylene content of the crystalline fraction (C2(CF)), determined by CRYSTEX QC analysis, in the range from 0.5 to 6.0 wt.-%;
d) an ethylene content of the soluble fraction (C2(SF)), determined by CRYSTEX QC analysis, in the range from 20 to 40 wt.-%;
e) an intrinsic viscosity of the crystalline fraction (iV(CF)), determined by CRYSTEX QC analysis, in the range from 1.10 to 2.10 dL/g;
f) an intrinsic viscosity of the soluble fraction (iV(SF)), determined by CRYSTEX QC analysis, in the range from 1.20 to 2.20 dL/g;
g) an inorganic residue content, as determined by calcination analysis according to DIN ISO 1172:1996, of 0.05 to 5.0 wt.-%; and
h) a density, determined according to ISO 1183-187, in the range from 890 to 950 kg/m³.

7. The polypropylene composition (PC) according to claim 1, wherein the mixed-plastic polypropylene blend (B) has:
a) a Charpy Notched impact strength (NIS) at 23° C., determined according to ISO 179 using 80×10×4 mm³ test bars injection-moulded in line with ISO 19069-2, in the range from 1.0 to 20.0 kJ/m²; and/or
b) a flexural modulus, determined according to ISO 178 using 80×10×4 mm³ test bars injection-moulded in line with ISO 19069-2, in the range from 1000 to 1600 MPa.

8. The polypropylene composition (PC) according to claim 1, having one or more, preferably all, of the following properties:
a) an ethylene content (C2(total)), determined by CRYSTEX QC analysis, in the range from 2.0 to 7.0 wt.-%;
b) a soluble fraction (SF) content in the range from 5.0 to 15.0 wt.-% and a crystalline fraction (CF) in the range from 85.0 to 95.0 wt.-%, both determined by CRYSTEX QC analysis;
c) an ethylene content of the crystalline fraction (C2(CF)), determined by CRYSTEX QC analysis, in the range from 1.5 to 6.0 wt.-%;
d) an ethylene content of the soluble fraction (C2(SF)), determined by CRYSTEX QC analysis, in the range from 15.0 to 35.0 wt.-%;
e) an intrinsic viscosity of the crystalline fraction (iV(CF)), determined by CRYSTEX QC analysis, in the range from 1.00 to 2.00 dL/g; and
f) an intrinsic viscosity of the soluble fraction (iV(SF)), determined by CRYSTEX QC analysis, in the range from 1.00 to 2.00 dL/g.

9. The polypropylene composition (PC) according to claim 1, having one or more of the following properties:
a) a density, determined according to ISO 1183-187, in the range from 1020 to 1100 kg/m³; and/or
b) an inorganic residue content, as determined according to ISO 3451-1:2019, of 18.0 to 25.0 wt.-%.

10. The polypropylene composition (PC) according to claim 1, having one or more of the following properties:
a) a heat deflection temperature A (HDT-A), determined according to ISO 75B with a load of 1.82 MPa, in the range from 60 to 70° C.; and/or
b) a heat deflection temperature B (HDT-B), determined according to ISO 75B with a load of 0.45 MPa, in the range from 112 to 125° C.

11. The polypropylene composition (PC) according to claim 1, having one or more of the following properties:
a) a Charpy Notched impact strength (NIS) at 23° C., determined according to ISO 179/1eA using 80×10×4 mm³ test bars injection-moulded in line with ISO 19069-2, in the range from 1.0 to 10.0 kJ/m²;
b) a Charpy Unnotched impact strength (UNIS) at 23° C., determined according to ISO 179/1eU using 80×10×4 mm³ test bars injection-moulded in line with ISO 19069-2, in the range from 30 to 80 kJ/m²;
c) a tensile modulus, determined according to ISO 527-2, in the range from 2400 to 5000 MPa; and/or
d) a flexural modulus, determined according to ISO 178 using 80×10×4 mm³ test bars injection-moulded in line with ISO 19069-2, in the range from 2400 to 5000 MPa.

12. The polypropylene composition (PC) according to claim 1, having one or more of the following properties:
a) a content of low boiling substances (LBS), determined by thermo-desorption analysis, 2016 in the range from 0 to 50 μg/g;
b) a content of high boiling substances (HBS), determined by thermo-desorption analysis, in the range from 0 to 350 μg/g;
c) an amount of fogging, determined according to the gravimetric method DI 75201:2011-11, method B, in the range from 0.10 to 1.50 mg; and
d) a total volatile organic compounds content (TVOC), determined according to VDA 277 January 1995, in the range from 4.0 to 18.0 μgC/g.

13. The polypropylene composition (PC) according to claim 1, wherein the mixed-plastic polypropylene blend (B) originates from post-consumer waste.

14. The polypropylene composition (PC) according to claim 1, wherein the mixed-plastic polypropylene blend (B) comprises one or more of limonene, polystyrene, polyamide-6 and fatty acids.

15. An article comprising the polypropylene composition according to claim 1 in an amount of at least 95 wt.-%.

16. The polypropylene composition (PC) according to claim 5, wherein the talc has one or more of the following properties:
a) a median diameter (d₅₀), determined according to ISO 13320 1, in the range from 0.1 to 3.0 μm; and
b) a top cut diameter (d₉₈), determined according to ISO 13320 1, in the range from 5.0 to 30 μm.
